(19) United States
(12) Patent Application Publication
(10) Pub. No.: US 2025/0355294 A1
(43) Pub. Date: Nov. 20, 2025

(54) DISPLAY DEVICE AND THERMAL DISSIPATION METHOD THEREOF

(71) Applicant: AUO Display Plus Corporation, Hsinchu City (TW)

(72) Inventors: Wei-Chou KUO, Hsinchu City (TW); Chi-Cheng CHENG, Hsinchu City (TW); Chi-Wen CHEN, Hsinchu City (TW); Ren-Wei HUANG, Hsinchu City (TW)

(21) Appl. No.: 18/957,072

(22) Filed: Nov. 22, 2024

(30) Foreign Application Priority Data
May 16, 2024 (TW) 113118231

(51) Int. Cl. G02F 1/1333; G02F 1/1335

(52) U.S. Cl. CPC G02F 1/133385; G02F 1/133331; G02F 1/133528

(57) ABSTRACT

A display device includes a case, a display module, a polarizer, a backlight module, an air flow channel, a cover glass, a first temperature sensor, and a second temperature sensor. The display module is disposed in the case, and the display module has a first side and a second side. The cover glass is located on the first side of the display module and is disposed on the case, wherein the cover glass has a display area and an edge area surrounding the display area. The polarizer is located between the cover glass and the display module. The backlight module is located on a second side of the display module and is disposed in the case. The first temperature sensor is disposed on the first surface of the cover glass adjacent to the polarizer. The second temperature sensor is disposed in the air flow channel.

### CROSS-REFERENCE TO RELATED APPLICATION

This application claims priority to Taiwan Application Serial Number 113118231, filed May 16, 2024, which is herein incorporated by reference in its entirety.

### BACKGROUND

### Field of Invention

The present disclosure relates to a display device and a thermal dissipation method thereof. More particularly, the present disclosure relates to a display device that is suitable for outdoor installation.

### Description of Related Art

For commercial display devices installed outdoors, the temperature of the polarizer will increase significantly under sunlight. Therefore, it is easy to cause deformation and/or abnormality of the polarizer and the internal light-enhancing film, which may lead to abnormality of the liquid crystal display module. However, with the trend of thinner display devices, it is difficult to set a temperature sensor directly in the polarizer area, and it is difficult to accurately activate the thermal dissipation mechanism when the temperature of the polarizer increases.

Accordingly, the present disclosure provides a display device that is able to detect the temperature of the isothermal region of the polarizer and a thermal dissipation method of the display device, so as to reduce abnormalities caused by excessive temperature of the polarizer.

### SUMMARY

In accordance with an aspect of the present disclosure, a display device is provided. The display device includes a case, a display module, a cover glass, a polarizer, a backlight module, an air flow channel, a first temperature sensor, and a second temperature sensor. The display module is disposed in the case and has a first side and a second side, wherein the second side is opposite to the first side. The cover glass is located on the first side and disposed on the case, and the cover glass has a display area and an edge area surrounding the display area. The polarizer is located between the cover glass and the display module. The backlight module is located on the second side and is disposed in the case. The first temperature sensor is disposed on a first surface of the cover glass adjacent to the polarizer and is located in the edge area of the cover glass. The second temperature sensor is disposed in the air flow channel.

According to some embodiments of the present disclosure, the display device further includes a printed circuit board disposed on the backlight module, and the second temperature sensor is located on the printed circuit board.

According to some embodiments of the present disclosure, the display device further includes a printed circuit board disposed on the case, and the air flow channel is located between the printed circuit board and the backlight module.

According to some embodiments of the present disclosure, wherein the first temperature sensor is disposed at one of the side edge of the edge area of the cover glass.

According to some embodiments of the present disclosure, wherein the first temperature sensor is disposed at one of the corner of the edge area of the cover glass.

In accordance with an aspect of the present disclosure, a thermal dissipation method for the display device is provided. The method includes following steps. The first temperature sensor is used to measure a first temperature of an isothermal region of the polarizer. The second temperature sensor is used to measure a second temperature of the air flow channel, wherein when the first temperature is equal to or less than the second temperature, the upper limit of the brightness of the backlight module is set to a first brightness. The polarizer temperature of the polarizer is estimated based on the first temperature and the second temperature. The estimated polarizer temperature is determined whether it is greater than an allowable value or not. When the estimated polarizer temperature is greater than the allowable value, the upper limit of the brightness of the backlight module is decreased from the first brightness to a second brightness.

According to some embodiments of the present disclosure, wherein when the estimated polarizer temperature is less than or equal to the allowable value, the upper limit of the brightness of the backlight module is increased from the second brightness to the first brightness.

In accordance with an aspect of the present disclosure, a thermal dissipation method for a display device is provided. The method includes following steps. A display device is provided. Providing a display device includes following steps. A case is provided. A display module is disposed in the case. A cover glass is disposed on the case. A polarizer is disposed between the cover glass and the display module. A backlight module is disposed in the case such that the display module is between the polarizer and the backlight module, wherein an air flow channel located between the case and the backlight module. A first temperature sensor is disposed on the cover glass and adjacent to the polarizer. A second temperature sensor is disposed in the air flow channel. A fan is disposed adjacent to the air flow channel, wherein the fan is configured to introduce and discharge a thermal dissipation air flow. The first temperature sensor is used to measure a first temperature of an isothermal region of the polarizer. The second temperature sensor is used to measure a second temperature of the air flow channel, wherein when the first temperature is equal to or less than the second temperature, the rotation speed of the fan is set to a first rotation speed. A polarizer temperature of the polarizer is estimated based on the first temperature and the second temperature. The estimated polarizer temperature is determined whether it is greater than an allowable value or not. When the estimated polarizer temperature is greater than the allowable value, the rotation speed of the fan is increased from the first rotation speed to a second rotation speed.

According to some embodiments of the present disclosure, wherein when the estimated polarizer temperature is less than or equal to the allowable value, the rotation speed of the fan is decreased from the second rotation speed to the first rotation speed.

According to some embodiments of the present disclosure, wherein when the first temperature is equal to or less than the second temperature, the upper limit of the brightness of the backlight module is set to a first brightness.

According to some embodiments of the present disclosure, wherein when the estimated polarizer temperature is greater than the allowable value, the upper limit of the brightness of the backlight module is decreased from the first brightness to a second brightness.

According to some embodiments of the present disclosure, wherein when the estimated polarizer temperature is less than or equal to the allowable value, the upper limit of the brightness of the backlight module is increased from the second brightness to the first brightness.

According to some embodiments of the present disclosure, the thermal dissipation method further includes disposing a printed circuit board on the backlight module when providing the display device, wherein the second temperature sensor is disposed on the printed circuit board.

According to some embodiments of the present disclosure, the thermal dissipation method further includes disposing a printed circuit board on the case when providing the display device, such that the air flow channel is located between the printed circuit board and the backlight module.

According to some embodiments of the present disclosure, the thermal dissipation method further includes disposing a thermal dissipation hole on the case to introduce and discharge the thermal dissipation air flow into the air flow channel.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 to FIG. 4 are cross-sectional view schematic diagrams of display devices, in accordance with some embodiments;

FIG. 5 to FIG. 6 are top-view schematic diagrams of display devices, in accordance with some embodiments; and

FIG. 7 to FIG. 9 are flow charts of the thermal dissipation methods, in accordance with some embodiments.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The terms used in the present disclosure are only used to describe specific embodiments and are not used to limit the present disclosure. Singular forms such as “a”, “this”, and “the”, as used in the present disclosure, also include the plural form.

Terms such as “comprise”, “include”, and “have” used in the present disclosure are open terms, which mean including but not limited to.

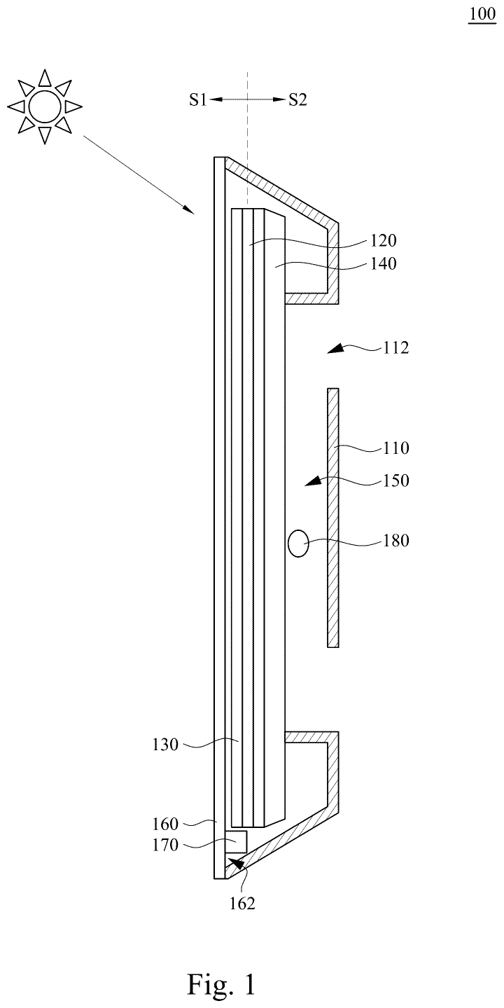

Firstly, referring to FIG. 1, FIG. 1 is a cross-sectional view schematic diagram of a display device 100. As shown in FIG. 1, the display device 100 includes case 110, a display module 120, a polarizer 130, a backlight module 140, an air flow channel 150, a cover glass 160, a first temperature sensor 170, and a second temperature sensor 180. The display module 120, the polarizer 130, the backlight module 140, the air flow channel 150, the first temperature sensor 170, and the second temperature sensor 180 are disposed in the space formed by the case 110 and the cover glass 160. The polarizer 130 is located at the first side S1 of the display module 120. Specifically, the polarizer 130 is located between the cover glass 160 and the display module 120. The backlight module 140 is located on the second side S2 of the display module 120, wherein the second side S2 is opposite to the first side S1.

As shown in FIG. 1, the air flow channel 150 is located between the case 110 and the backlight module 140. In some embodiments, the case 110 is provided with thermal dissipation holes 112 such that external air can enter the air flow channel 150. The cover glass 160 is located on the first side S1 of the display module 120. The external air (such as the thermal dissipation air flow 192 described below) can enter the air flow channel 150 from the thermal dissipation holes 112, such that the heat inside the display device 100 leaves along with the external air. As the external air can enter the air flow channel 150 from the thermal dissipation holes 112 and the display module 120 blocks most of the sunlight, in most situations, the temperature of air flow channel 150 is approximately equal to the environment temperature.

The first temperature sensor 170 is disposed on the first surface 162 of the cover glass 160, wherein the first surface 162 is adjacent to the polarizer 130. Specifically, the first temperature sensor 170 is disposed inside the display device 100 and adjacent to the polarizer 130, whereby the first temperature sensor 170 is used to measure the isothermal region of the cover glass 160 and/or the polarizer 130. For example, in this embodiment, when sunlight irradiates the cover glass 160 and/or the polarizer 130 and causes the temperature to rise. The temperature of the isothermal region of the cover glass 160 and/or the polarizer 130 can be obtained through the first temperature sensor 170 to estimate the data related to the temperature rise of the polarizer 130 due to sunlight exposure. The second temperature sensor 180 is disposed in the air flow channel 150 to measure the temperature of the air flow channel 150. In some embodiments, the temperature of air flow channel 150 is approximately equal to the environment temperature. Therefore, the second temperature sensor 180 can obtain relevant data that is approximately equal to the environment temperature.

Taken together, with the trend of thinner display devices, it is necessary to evaluate the temperature of the polarizer 130 to accurately activate the thermal dissipation mechanism when the temperature of the polarizer increases. In this embodiment, the first temperature sensor 170 is disposed on the cover glass 160 adjacent to the polarizer 130. The temperature data of the isothermal region closest to the sunlight irradiation of the cover glass 160 and/or the polarizer 130 can be detected. The temperature data of the isothermal region can be analyzed and compared with the environment temperature data obtained by the second temperature sensor 180. Therefore, in the design of thinner display devices, it is also possible to measure the temperature of the isothermal region of the polarizer 130, and then estimate the temperature of the polarizer 130. While reducing the thickness of the display devices, the thermal dissipation mechanism can also be accurately activated when the temperature of the polarizer 130 rises.

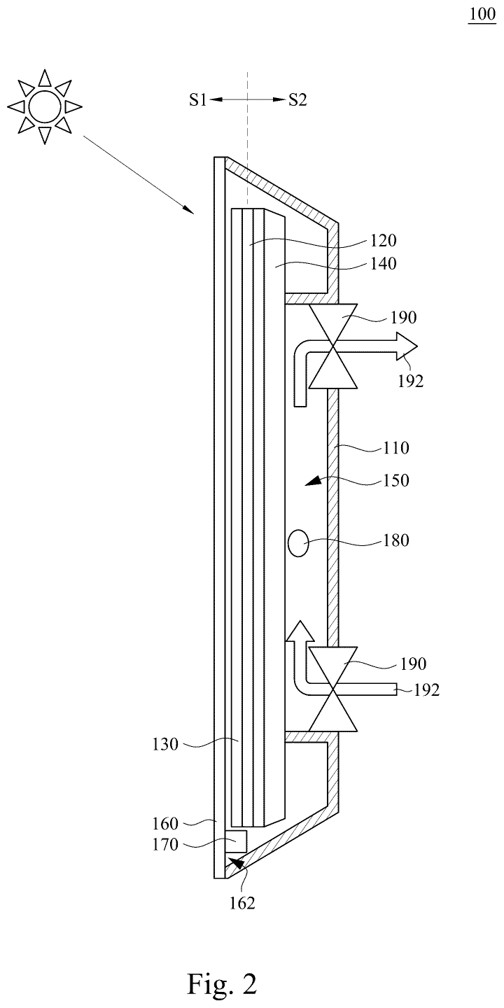

Referring to FIG. 2, the display device 100 further includes a fan 190. Fan 190 is adjacent to air flow channel 150. When the fan 190 is operating, the thermal dissipation air flow 192 can be introduced into the display device 100 from some of the thermal dissipation holes 112, and then discharged out of the display device 100 through other thermal dissipation holes 112. In this way, the fan 190 can introduce the thermal dissipation air flow 192 to increase the thermal dissipation efficiency. In addition, as shown in FIG. 2, when the thermal dissipation air flow 192 flows into the air flow channel 150, the thermal dissipation air flow 192 may also flow through the second temperature sensor 180. At this time, the second temperature sensor 180 can detect the temperature of the thermal dissipation air flow 192 and the air flow channel 150.

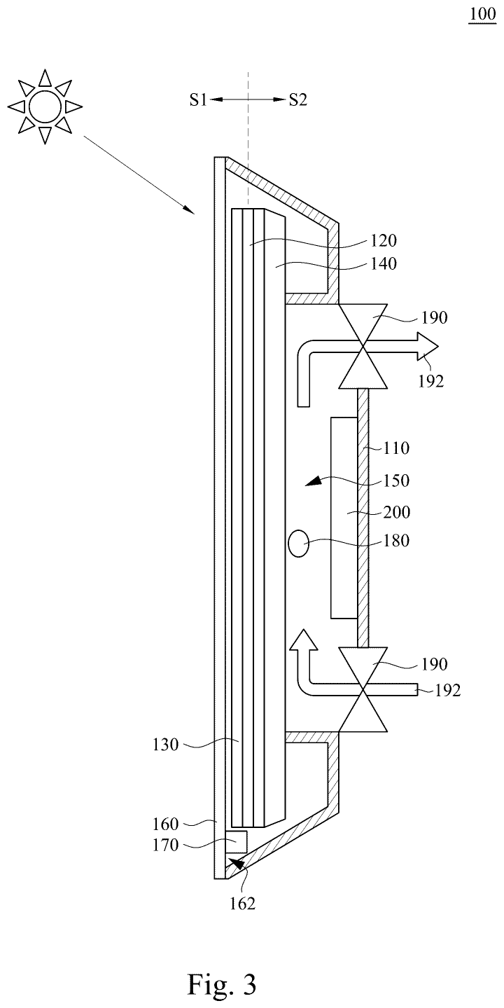

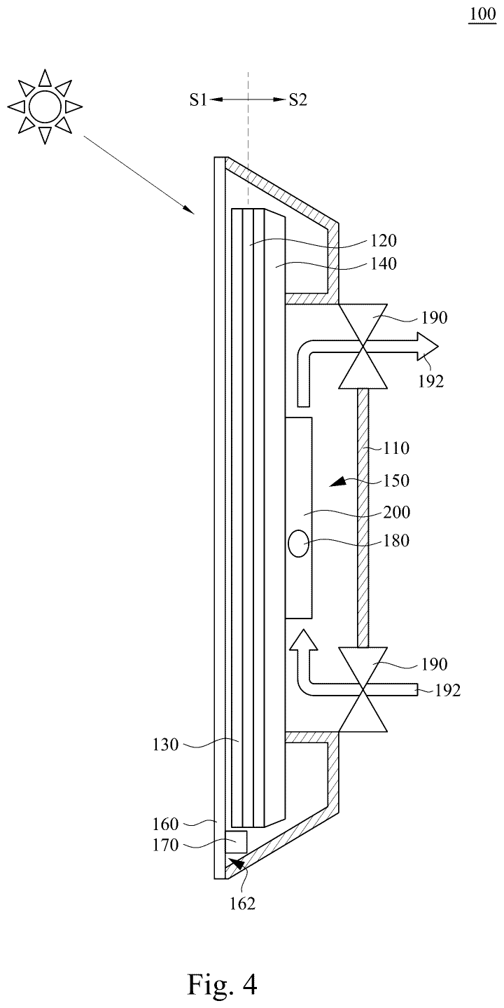

Referring to FIG. 3 and FIG. 4, the display device 100 further includes a printed circuit board 200. In FIG. 3, the printed circuit board 200 is disposed on the case 110 and located in the display device 100. The air flow channel 150 and the second temperature sensor 180 are located between the circuit board 200 and the backlight module 140. When the circuit board 200 is disposed on the case 110, the air flow channel 150 is located between the printed circuit board 200 and the backlight module 140. The heat generated by the printed circuit board 200 can be directly taken away through the thermal dissipation air flow 192 in the air flow channel 150. Therefore, the heat generated by the circuit board 200 can be prevented from interfering with the polarizer 130.

In FIG. 4, the printed circuit board 200 is disposed on the backlight module 140, and the second temperature sensor 180 is disposed on the printed circuit board 200. When the second temperature sensor 180 is disposed on the printed circuit board 200, the second temperature sensor 180 may also measure the heat energy generated by the printed circuit board 200. In some embodiments, the second temperature sensor 180 can be disposed at an area far away from the heating element of the printed circuit board 200 to reduce the influence of the heating element of the printed circuit board 200 on the second temperature sensor 180. Or, in some other embodiments, if the second temperature sensor 180 measures that the temperature of the printed circuit board 200 rises due to the display device 100 running for too long, the thermal dissipation mechanism can also be activated for the printed circuit board 200. For example, increasing the rotation speed of the fan 190 to introduce more thermal dissipation air flow 192 and so on.

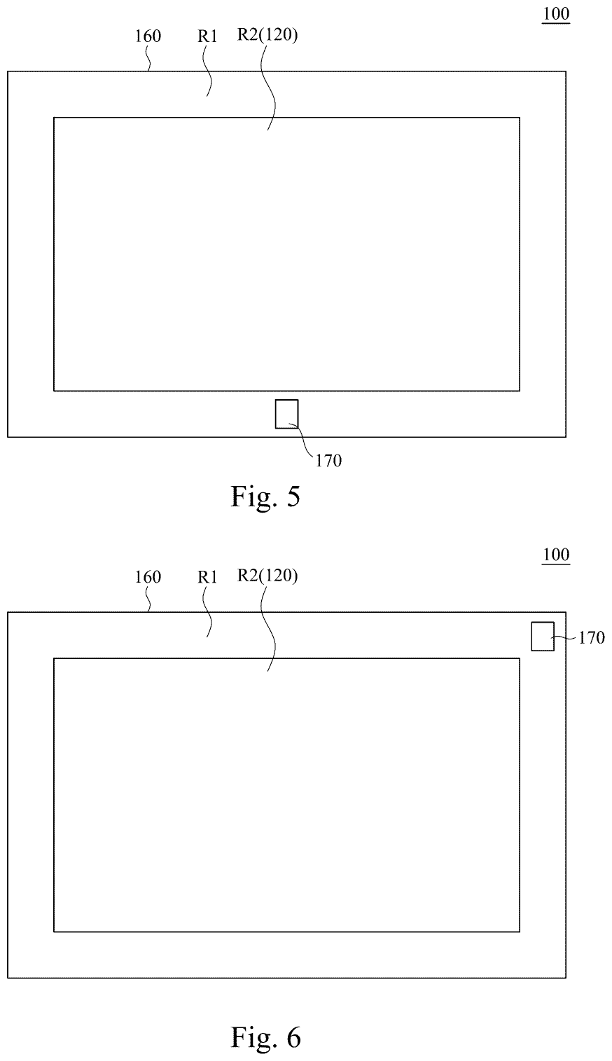

Referring to FIG. 5 and FIG. 6, the cover glass 160 of the display device 100 has a display area R2 and an edge area R1 surrounding the display area R2, wherein the display area R2 overlaps with the projection of the display module 120. Furthermore, the first temperature sensor 170 is disposed in the edge region R1 of the cover glass 160. In FIG. 5, the first temperature sensor 170 is disposed on the long side edge of the display device 100. In FIG. 6, the first temperature sensor 170 is disposed at the corner of the display device 100. It should be noted that the position of the first temperature sensor 170 can be adjusted according to requirements, and for example, it can also be disposed on the short side edge of the display device 100. In some embodiments, when the lengths of the side of the display device 100 are the same, the first temperature sensor 170 can be disposed on any side edge. In some embodiments, a groove may be formed on the case 110 to provide a space to dispose the first temperature sensor 170. As mentioned above, under the trend of thinner display devices, disposing the first temperature sensor 170 in the edge area R1 can measure the temperature of the isothermal region of the polarizer 130. Also, the rising temperature of the polarizer 130 can be simulated and estimated using the method described below.

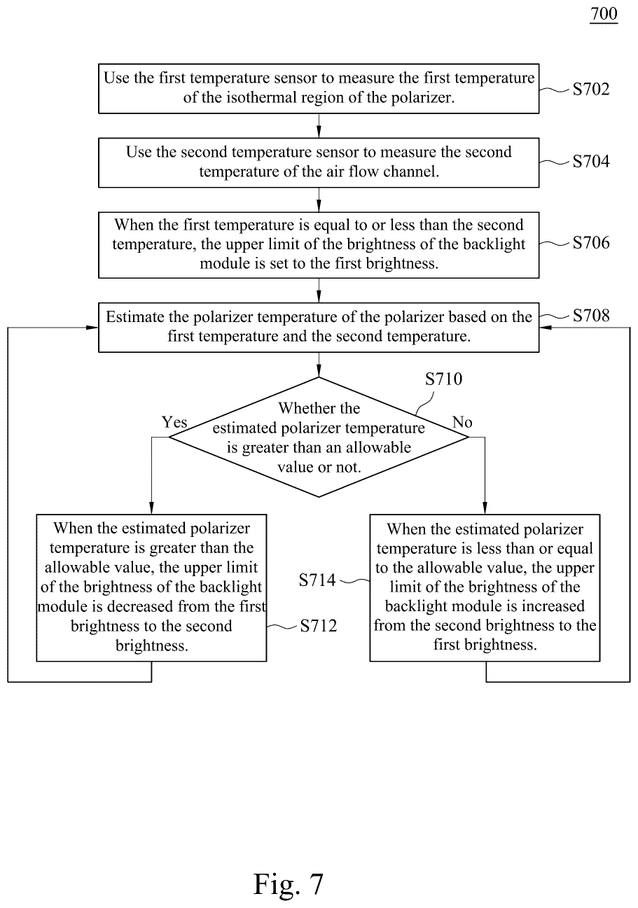

Next, the thermal dissipation method 700 of the display device 100 is described. FIG. 7 is a flow chart of the thermal dissipation method 700. Please refer to FIG. 1 and FIG. 7 together. First, in step S702, the first temperature sensor 170 is used to measure the first temperature of the isothermal region of the polarizer 130. In step S704, the second temperature sensor 180 is used to measure the second temperature of the air flow channel 150. In step S706, when the first temperature is equal to or less than the second temperature, the upper limit of the brightness of the backlight module 140 is set to the first brightness. Since the brightness of the backlight module 140 of the display device 100 installed outdoors may change with the environment brightness, the upper limit of the brightness of the backlight module 140 is set to limit the upper limit of the heat emitted by the backlight module 140. In step S708, the polarizer temperature of the polarizer is estimated based on the first temperature and the second temperature. In step S710, it is determined whether the estimated polarizer temperature of the polarizer is greater than the allowable value or not. In some embodiments, when the maximum operating temperature of the polarizer is 85° C., the allowable value can be set at 83.5° C. In step S712, when the estimated polarizer temperature is greater than the allowable value, the thermal dissipation mechanism is activated. Specifically, the upper limit of the brightness of the backlight module 140 is decreased from the first brightness to the second brightness. In step S714, when the estimated polarizer temperature is less than or equal to the allowable value, the upper limit of brightness of the backlight module 140 is increased from the second brightness to the first brightness. It should be noted that in the thermal dissipation method 700, step S710, step S712, and step S714 can be performed cyclically. For example, when the first estimated polarizer temperature is less than the allowable value, in step S714, the brightness of the backlight module 140 is maintained at the first brightness. Alternatively, after performing step S714, when the re-estimated polarizer temperature is greater than the allowable value, step S712 can be performed again to activate the thermal dissipation mechanism. Moreover, when the re-estimated polarizer temperature is less than the allowable value, step S714 can be performed again to return the brightness of the backlight module 140 to the first brightness.

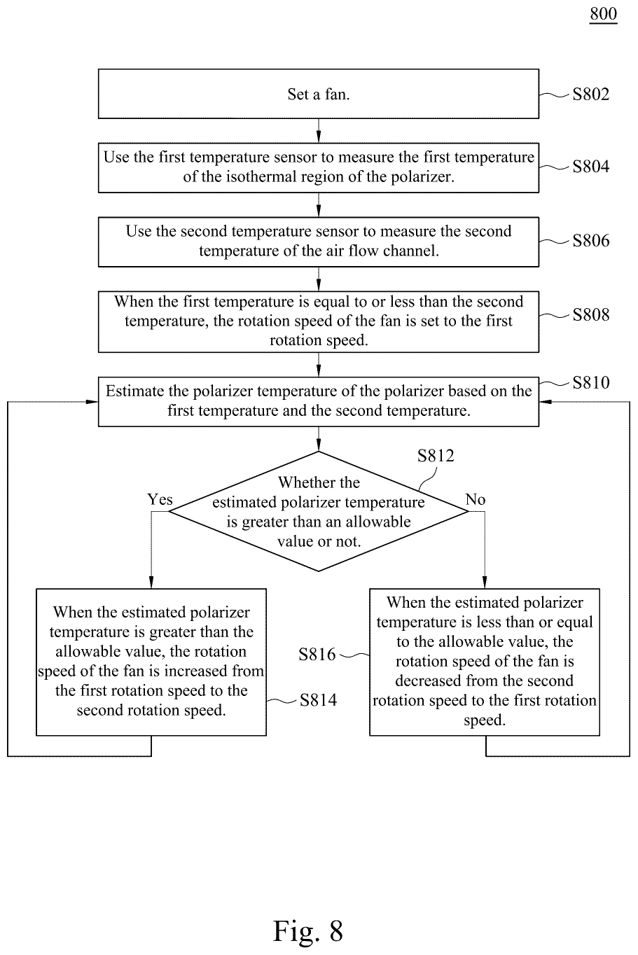

Next, the thermal dissipation method 800 of the display device 100 is described. FIG. 8 is a flow chart of the thermal dissipation method. Please refer to FIG. 1 and FIG. 8 together. First, in step S802, the fan 190 is disposed adjacent to the air flow channel 150 (to form a display device 100 similar to that of FIG. 2 to FIG. 4). As described above, the fan 190 is configured to introduce and discharge the thermal dissipation air flow 192. In step S804, the first temperature sensor 170 is used to measure the first temperature of the isothermal region of the polarizer 130. In step S806, the second temperature sensor 180 is used to measure the second temperature of the air flow channel 150. In step S808, when the first temperature is equal to or less than the second temperature, the rotation speed of the fan 190 is set to the first rotation speed. In step S810, the polarizer temperature of the polarizer is estimated based on the first temperature and the second temperature. In step S812, it is determined whether the estimated polarizer temperature is greater than the allowable value or not. In step S814, when the estimated polarizer temperature is greater than the allowable value, the thermal dissipation mechanism is activated. Specifically, the rotation speed of the fan 190 is increased from the first rotation speed to the second rotation speed. In step S816, when the estimated polarizer temperature is less than or equal to the allowable value, the rotation speed of the fan 190 is decreased from the second rotation speed to the first rotation speed. It should be noted that in the thermal dissipation method 800, step S812, step S814, and step S816 can be performed cyclically. For example, when the estimated polarizer temperature is less than the allowable value, in step S814, the rotation speed is maintained at the first rotation speed. Alternatively, after performing step S816, when the re-estimated polarizer temperature is greater than the allowable value, step S814 can be performed again to activate the thermal dissipation mechanism. Moreover, when the re-estimated polarizer temperature is less than the allowable value, step S816 can be performed again to return the rotation speed to the first rotation speed.

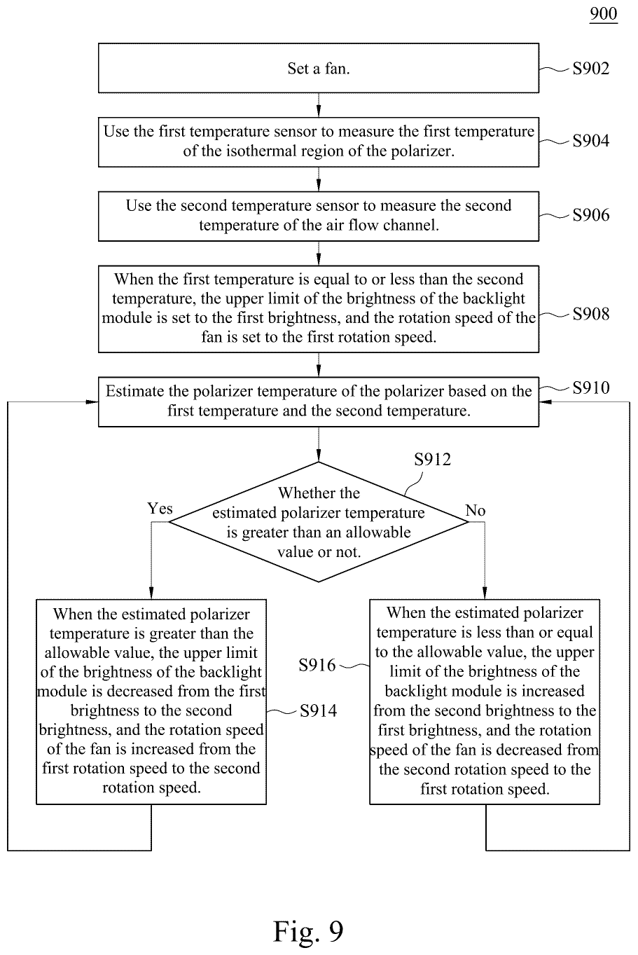

In some embodiments, the thermal dissipation method 700 and the thermal dissipation method 800 may also be combined to enhance thermal dissipation efficiency. FIG. 9 is a flow chart of the thermal dissipation method. Please refer to FIG. 1 and FIG. 9 together. First, in step S902, the fan 190 is disposed adjacent to the air flow channel 150 (to form a display device 100 similar to that of FIG. 2 to FIG. 4). As described above, the fan 190 is configured to introduce and discharge the thermal dissipation air flow 192. In step S904, the first temperature sensor 170 is used to measure the first temperature of the isothermal region of the polarizer 130. In step S906, the second temperature sensor 180 is used to measure the second temperature of the air flow channel 150. In step S908, when the first temperature is equal to or less than the second temperature, the upper limit of the brightness of the backlight module 140 is set to the first brightness, and the rotation speed of the fan 190 is set to the first rotation speed. Since the brightness of the backlight module 140 of the display device 100 installed outdoors may change with the environment brightness, the upper limit of the brightness of the backlight module 140 is set to limit the upper limit of the heat emitted by the backlight module 140. In step S910, the polarizer temperature of the polarizer is estimated based on the first temperature and the second temperature. In step S912, it is determined whether the estimated polarizer temperature is greater than the allowable value or not. In step S914, when the estimated polarizer temperature is greater than the allowable value, a high-efficiency thermal dissipation mechanism is activated. Specifically, the upper limit of the brightness of the backlight module 140 is decreased from the first brightness to the second brightness, and the rotation speed of the fan 190 is increased from the first rotation speed to the second rotation speed. In step S916, when the estimated polarizer temperature is less than or equal to the allowable value, the upper limit of brightness of the backlight module 140 is increased from the second brightness to the first brightness, and the rotation speed of the fan 190 is decreased from the second rotation speed to the first rotation speed. As described in the thermal dissipation method 700 and the thermal dissipation method 800, in the thermal dissipation method 900, step S912, step S914, and step S916 may be performed cyclically.

In some embodiments, the thermal dissipation method 900 may use the following equation (1) to simulate and evaluate the temperature of the polarizer.

$${T}_{POL} = α \times {T}_{A} + β \times {T}_{B} + γ \times BLU + δ \times FS + ε ; \qquad ( 1 )$$

In equation (1), T_{POL} is the temperature of the polarizer, T_{A} is the first temperature measured by the first temperature sensor, T_{B} is the second temperature measured by the second temperature sensor, BLU is the upper limit of the brightness of the backlight module, FS is the rotation speed of the fan. Moreover, the coefficients α, β, γ, δ, and ε may vary based on the thermal dissipation design of each display device. For example, in some embodiments, when the polarizer 130 is more susceptible to temperature rise, appropriate coefficients α, β, γ, δ, and ε can be set such that the rotation speed of the fan can be higher, or the upper limit of the brightness of the backlight module can be even lower.

In other embodiments, if equation (1) is used to estimate the temperature of the polarizer, when the estimated polarizer temperature T_{POL} gradually increases but has not yet reached the allowable value, the rotation speed can be increased from the first rotation speed in proportion to the coefficient δ; such that when the estimated polarizer temperature T_{POL} reaches the allowable value, the rotation speed reaches the second rotation speed; Similarly, when the estimated polarizer temperature T_{POL} gradually decreases, the rotation speed can be decreased in proportion to the coefficient δ, such that when the first temperature is equal to the second temperature, the rotation speed decreases to the first rotation speed. The upper limit of the brightness of the backlight module can also be dynamically adjusted according to the ratio of the coefficient γ as described above. It is also possible to adjust the rotation speed of the fan and the upper limit of the brightness of the backlight module dynamically at the same time.

In summary, the thermal dissipation method of the present disclosure, the temperature of the isothermal temperature region of the polarizer is measured through a temperature sensor disposed under the cover glass, and the temperature in the display device is measured through a temperature sensor installed in the air flow channel to simulate and evaluate the temperature rise of the polarizer due to sunlight exposure. By evaluating the current temperature data of the polarizer through simulation, the thermal dissipation mechanism can be accurately activated while the temperature of the polarizer rises. For example, the thermal dissipation mechanism includes decreasing the brightness of the backlight and/or increasing the fan speed when the polarizer temperature rises. The display device of the present disclosure can reduce the deformation caused by the rise in temperature of the polarizer so that the display is suitable for maintaining normal operation under high temperatures outdoors.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A display device, comprising:
a case;
a display module disposed in the case and having a first side and a second side, wherein the second side is opposite to the first side;
a cover glass located on the first side and disposed on the case, and the cover glass has a display area and an edge area surrounding the display area;
a polarizer located between the cover glass and the display module;
a backlight module located on the second side and disposed in the case;
an air flow channel located between the case and the backlight module;
a first temperature sensor disposed on a first surface of the cover glass adjacent to the polarizer and located in the edge area of the cover glass; and
a second temperature sensor disposed in the air flow channel.

2. The display device of claim 1, further comprising:
a printed circuit board disposed on the backlight module, and the second temperature sensor is located on the printed circuit board.

3. The display device of claim 1, further comprising:
a printed circuit board disposed on the case, and the air flow channel is located between the printed circuit board and the backlight module.

4. The display device of claim 1, wherein the first temperature sensor is disposed at one of the side edge of the edge area of the cover glass.

5. The display device of claim 1, wherein the first temperature sensor is disposed at one of the corner of the edge area of the cover glass.

6. A thermal dissipation method for the display device of claim 1, comprising:
using the first temperature sensor to measure a first temperature of an isothermal region of the polarizer;
using the second temperature sensor to measure a second temperature of the air flow channel, wherein when the first temperature is equal to or less than the second temperature, the upper limit of the brightness of the backlight module is set to a first brightness;
estimating a polarizer temperature of the polarizer based on the first temperature and the second temperature;
determining whether the estimated polarizer temperature is greater than an allowable value; and
when the estimated polarizer temperature is greater than the allowable value, the upper limit of the brightness of the backlight module is decreased from the first brightness to a second brightness.

7. The thermal dissipation method of claim 6, wherein when the estimated polarizer temperature is less than or equal to the allowable value, the upper limit of the brightness of the backlight module is increased from the second brightness to the first brightness.

8. A thermal dissipation method for a display device, comprising:
providing a display device, comprising:
providing a case;
disposing a display module in the case;
disposing a cover glass on the case;
disposing a polarizer between the cover glass and the display module;
disposing a backlight module in the case such that the display module is between the polarizer and the backlight module, wherein an air flow channel located between the case and the backlight module;
disposing a first temperature sensor on the cover glass and adjacent to the polarizer;
disposing a second temperature sensor in the air flow channel; and
disposing a fan adjacent to the air flow channel, wherein the fan is configured to introduce and discharge a thermal dissipation air flow;
using the first temperature sensor to measure a first temperature of an isothermal region of the polarizer;
using the second temperature sensor to measure a second temperature of the air flow channel, wherein when the first temperature is equal to or less than the second temperature, the rotation speed of the fan is set to a first rotation speed;
estimating a polarizer temperature of the polarizer based on the first temperature and the second temperature;
determining whether the estimated polarizer temperature is greater than an allowable value; and
when the estimated polarizer temperature is greater than the allowable value, the rotation speed of the fan is increased from the first rotation speed to a second rotation speed.

9. The thermal dissipation method of claim 8, wherein when the estimated polarizer temperature is less than or equal to the allowable value, the rotation speed of the fan is decreased from the second rotation speed to the first rotation speed.

10. The thermal dissipation method of claim 8, wherein when the first temperature is equal to or less than the second temperature, the upper limit of the brightness of the backlight module is set to a first brightness.

11. The thermal dissipation method of claim 10, wherein when the estimated polarizer temperature is greater than the allowable value, the upper limit of the brightness of the backlight module is decreased from the first brightness to a second brightness.

12. The thermal dissipation method of claim 11, wherein when the estimated polarizer temperature is less than or equal to the allowable value, the upper limit of the brightness of the backlight module is increased from the second brightness to the first brightness.

13. The thermal dissipation method of claim 8, further comprising:
disposing a printed circuit board on the backlight module when providing the display device, wherein the second temperature sensor is disposed on the printed circuit board.

14. The thermal dissipation method of claim 8, further comprising:
disposing a printed circuit board on the case when providing the display device, such that the air flow channel is located between the printed circuit board and the backlight module.

15. The thermal dissipation method of claim 8, further comprising:
disposing a thermal dissipation hole on the case to introduce and discharge the thermal dissipation air flow into the air flow channel.
